(19) United States
(12) Patent Application Publication
(10) Pub. No.: US 2022/0216580 A1
(43) Pub. Date: Jul. 7, 2022

(54) WAVEGUIDE JUNCTION FOR SPLITTING AND/OR COMBINING RADIO FREQUENCY ENERGY AND METHOD FOR MANUFACTURE

(71) Applicant: WISENSE TECHNOLOGIES LTD., Tel Aviv (IL)

(72) Inventors: Zeev ILUZ, Gan-Yavne (IL); Moshik Moshe COHEN, Or Yehuda (IL)

(73) Assignee: WISENSE TECHNOLOGIES LTD., Tel Aviv (IL)

(21) Appl. No.: 17/607,919

(22) PCT Filed: Apr. 30, 2020
(86) PCT No.: PCT/IL2020/050482

§ 371 Date: Nov. 1, 2021

Related U.S. Application Data
(60) Provisional application No. 62/841,856, filed on May 2, 2019.

(51) Int. Cl. H01P 3/123; H01P 5/20

(52) U.S. Cl. CPC H01P 3/123; H01P 5/20

(57) ABSTRACT

A waveguide junction comprising a dual-ridged base waveguide, a single-ridged first arm waveguide, connected to the base waveguide and a single-ridged, second arm waveguide, connected to the base waveguide and to the first arm waveguide.

### FIELD OF THE INVENTION

The present invention relates generally to waveguides of radio frequency (RF) energy. More specifically, the present invention relates to waveguide junctions for splitting and/or combining RF energy.

### BACKGROUND OF THE INVENTION

Waveguides are routinely used to convey radio-frequency (RF) energy through a predefined path and may be used with RF applications including for example telecommunications, radar and the like.

As known in the art, waveguides are commonly structured as hollow pipes having a polygonal (e.g., rectangular) cross section, where at least one dimension (e.g., a width of the pipe) is set according to the working RF wavelength.

In some commercially available implementations, a ridge may be placed along a side of the rectangular pipe, thus accommodating an internal pathway for the conveyed RF energy around the circumference of the ridge. As known in the art, a ridged waveguide implementation that is utilized to convey RF energy of a specific wavelength may have a reduced dimensionality (e.g., a shorter width) in relation to an equivalent, ridge-less waveguide, conveying RF energy of the same wavelength.

As known in the art, waveguide junctions may be used to propagate RF energy through a first waveguide that may be referred herein as a ‘base’ waveguide and spilt the RF energy to two or more branching waveguides that may be referred herein as ‘arm’ waveguides. Similarly, waveguide junctions may be used to combine RF energy from the two or more arm waveguides into the base waveguide.

As known in the art, gapped or slotted waveguides may include a set of gaps, slots, holes or apertures, placed at a predefined location and/or spatial frequency, to allow emittance of RF energy from the waveguide in a direction that is substantially perpendicular to the direction of RF energy propagation within the waveguide. Such gapped waveguides may be employed, for example, in an RF antenna, and may be configured to emit RF energy through the set of apertures.

The location and/or spatial frequency of the apertures may be set according to the wavelength of the working RF energy. For example, as the RF frequency is increased, so would the spatial frequency of the apertures, to match the decreased RF wavelength.

As known in the art, integrity of a signal that is emitted through a gapped waveguide may be dependent upon the number of apertures in the waveguide and upon the distances between the RF feeding point and the respective emittance apertures. For example, the signal's integrity may be reduced as the number of apertures is increased and/or as the distance between the RF feeding point and each respective aperture is increased.

### SUMMARY OF THE INVENTION

A waveguide junction that may exploit structural benefits of ridged waveguides (e.g., having a reduced dimensionality), and evenly split and/or combine the propagation of conveyed RF energy between a central feeding point and a pair of arm waveguides (e.g., to produce an emitted signal of improved integrity) is therefore desired.

Embodiments of the present invention may include a waveguide junction that may include: a dual-ridged base waveguide; a single-ridged first arm waveguide, connected to the base waveguide; and a single-ridged, second arm waveguide, connected to the base waveguide and to the first arm waveguide.

According to some embodiments, the base waveguide, the first arm waveguide and the second arm waveguide may be aligned in a perpendicular T-shaped junction. Alternately, or additionally the base waveguide may be connected to at least one of the first arm waveguide and second arm waveguide so as to form a Y-shaped junction.

According to some embodiments, at least one of the base waveguide, the first arm waveguide and the second arm waveguide may be characterized by one of a polygonal (e.g., rectangular) cross section and a circular cross section.

According to some embodiments, a ridge of the first arm waveguide may meet a first ridge of the base waveguide in a first position, such that a cross-section of the waveguide junction at the first position may include a first profile. Additionally, or alternately, a ridge of the second arm waveguide may meet a second ridge of the base waveguide in a second position, such that a cross-section of the waveguide junction at the second position may include a second profile.

One or more of the first profile and the second profile may be or may include: a right-angled corner profile, a non-overlapping stair-shaped profile, a partially-overlapping stair-shaped profile, a trimmed right-angled corner profile, a rounded right-angled corner profile and a combination thereof.

At least one of the first profile and the second profile may be selected so as to transfer RF energy, at a working frequency of the waveguide junction (e.g., at a frequency that is above the waveguide's cutoff frequency, as known in the art), between the base waveguide and a respective arm waveguide, at a required transfer ratio as elaborated herein.

According to some embodiments, the first profile may be dissimilar from the second profile, to produce a non-symmetrical junction, configured to operate as at least one of: an RF energy splitter having a non-equal splitting ratio and an RF energy combiner having a non-equal combining ratio.

Embodiments of the present invention may include a waveguide junction, that may include: a base waveguide; a first arm waveguide, connected to the base waveguide; and a second arm waveguide connected to the base waveguide. The base waveguide may include a first ridge placed along a first side of the base waveguide and a second ridge placed along a second side of the base waveguide. The first arm waveguide may include a third ridge placed along a side of the first arm waveguide and the second arm waveguide may include a fourth ridge placed along a side of the second arm waveguide.

The base waveguide may be connected to at least one of the first arm waveguide and second arm waveguide and the first arm waveguide may be perpendicular to the base waveguide and colinear with the second arm waveguide so as to form a perpendicular T-shaped junction. Alternately, or additionally, the base waveguide may be connected to at least one of the first arm waveguide and second arm waveguide so as to form a Y-shaped junction.

According to some embodiments, one or more of the base waveguide, the first arm waveguide and the second arm waveguide may have one of a circular cross section and a polygonal (e.g., rectangular) cross section.

According to some embodiments, the third ridge may meet the first ridge in a first position and the fourth ridge meets the second ridge in a second position.

The first ridge may be juxtaposed with the third ridge at the first position such that a cross-section of the waveguide junction at the first position may include a first profile and wherein the first profile may be selected from a list consisting: a right-angled corner profile, a non-overlapping stair-shaped profile, a partially-overlapping stair-shaped profile, a trimmed right-angled corner profile, a rounded right-angled corner profile and a combination thereof.

Alternately, or additionally, the second ridge may be juxtaposed with the fourth ridge at the second position such that a cross-section of the waveguide junction at the second position may include a second profile and wherein the second profile may be selected from a list consisting: a right-angled corner profile, a non-overlapping stair-shaped profile, a partially-overlapping stair-shaped profile, a trimmed right-angled corner profile, a rounded right-angled corner profile and a combination thereof.

According to some embodiments, the first profile may be dissimilar from the second profile, to produce a non-symmetrical junction, configured to operate as at least one of an RF energy splitter, with non-equal splitting ratio and an RF energy combiner, with non-equal combining ratio.

The first ridge may be juxtaposed with the third ridge at the first position such that at least a portion of a width of the first ridge may be manifested by a first stair in the first profile and at least a portion of a width of the third ridge may be manifested by a second stair in the first profile. Alternately, or additionally, the second ridge may be juxtaposed with the fourth ridge at the second position such that at least a portion of a width of the second ridge may be manifested by a first stair in the second profile and at least a portion of a width of the fourth ridge may be manifested by a second stair in the second profile.

According to some embodiments, the waveguide junction may include a cover, positioned at a side of the first arm waveguide and second arm waveguide that may be opposite to the base waveguide. The cover may include one or more apertures, so as to allow emittance of RF energy through the apertures, and wherein the emittance of RF energy through the apertures may be symmetric in relation to a center-line of the base waveguide.

Embodiments of the present invention may include a method of producing a waveguide junction. Embodiments of the method may include:

connecting a first single-ridged arm waveguide to a dual-ridged base waveguide in a first position; and

connecting a second single-ridged arm waveguide to the dual-ridged base waveguide in a second position where each of the first arm waveguide, second arm waveguide and base waveguide may be adapted to carry RF energy at a frequency that may be equal to or higher than a selected cutoff frequency.

According to some embodiments, connecting the first arm waveguide to the base waveguide may include juxtaposing a ridge of the first arm waveguide with a first ridge of the base waveguide in the first position, such that a cross-section of the waveguide junction at the first position may include a first profile. Alternately, or additionally, connecting the second arm waveguide to the base waveguide may include juxtaposing a ridge of the second arm waveguide with a second ridge of the base waveguide in the second position, such that a cross-section of the waveguide junction at the second position may include a second profile.

Embodiments of the method may include selecting at least one of the first profile and second profile according to a received required RF transfer ratio, wherein each one of the first profile and the second profile may be or may include: a right-angled corner profile, a non-overlapping stair-shaped profile, a partially-overlapping stair-shaped profile, a trimmed right-angled corner profile, a rounded right-angled corner profile and a combination thereof.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1C are schematic, isometric views of segments of ridged waveguides that may be included in a waveguide junction, according to embodiments of the present invention;

FIGS. 1B and 1D are schematic, front views of segments of ridged waveguides that may be included in a waveguide junction, according to embodiments of the present invention;

FIGS. 2A and 2C are schematic, isometric views of segments of dual-ridged waveguides that may be included in a waveguide junction, according to embodiments of the present invention;

FIGS. 2B and 2D are schematic, front views of segments of dual-ridged waveguides that may be included in a waveguide junction, according to embodiments of the present invention;

FIG. 3A is a schematic cross-section of a waveguide junction, according to embodiments of the present invention;

FIG. 3B is a schematic cross-section of a waveguide junction, according to embodiments of the present invention;

FIG. 3C is a schematic cross-section of a waveguide junction, according to embodiments of the present invention;

FIG. 3D is a schematic cross-section of a waveguide junction, according to embodiments of the present invention;

FIG. 4 is an isometric view of a waveguide junction, according to embodiments of the present invention;

FIG. 5 is an isometric view of a waveguide junction, according to embodiments of the present invention; and

FIG. 6 is a flow diagram, depicting a method of producing a waveguide junction, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention include a waveguide junction for transferring RF energy between a dual-ridged waveguide and two single-ridged waveguides.

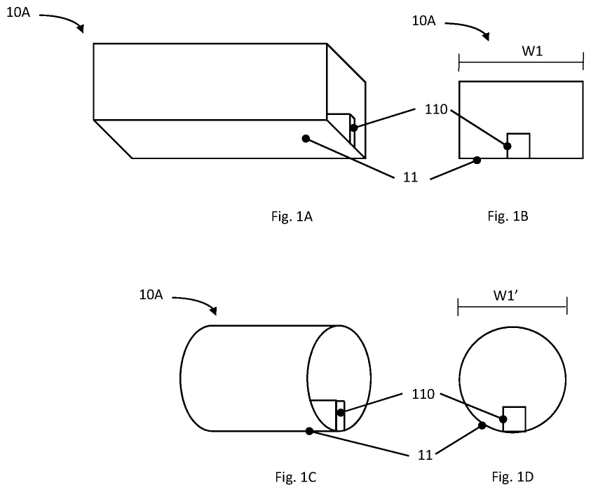

Reference is now made to FIGS. 1A, 1B, 1C and 1D which are schematic isometric views and schematic front views of a segment of a ridged waveguide that may be included in a waveguide junction, according to embodiments of the present invention.

As shown in FIGS. 1A and 1B, and as known in the art, a single ridged waveguide 10A may be implemented as a pipe having a polygonal (e.g., rectangular) cross section (except for any ridge or inset that may exist). As known in the art, where at least one dimension (e.g., a width of the pipe, marked as W1) may be set according to the working RF wavelength. For example, as known in the art, a designer may select a cutoff RF frequency, and the at least one dimension may be set so as to accommodate the selected cutoff frequency, such that the waveguide may effectively transfer RF energy that has a frequency equal to, or higher than the cutoff frequency.

As also known in the art, a ridge 110 may be placed along a side 11 of waveguide 10A thus forming a ridged waveguide 10A. It should be appreciated that a person skilled in the art would understand as known that ridged waveguides may typically be of lesser or smaller dimensionality (e.g., have at least one smaller dimension such as a smaller ‘W1’), in comparison with non-ridged waveguides characterized by the same cutoff frequency.

Alternately, as shown in FIGS. 1C and 1D, and as known in the art, a single ridged waveguide 10A may be implemented as a pipe having a circular or round cross section (except for any ridge or inset that may exist), where at least one dimension (e.g., a width of the pipe, marked as W1′) may be set according to the working RF wavelength. A ridge 110 may be placed along a side, arc or edge 11′ of waveguide 10A thus forming a ridged waveguide 10A.

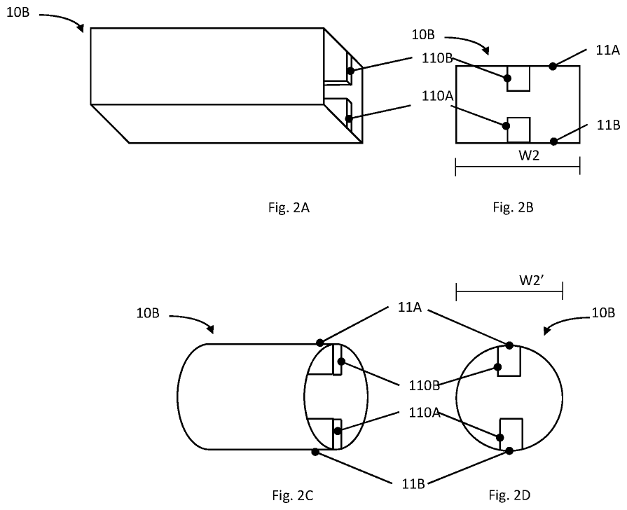

Reference is now made to FIG. 2A, 2B, 2C and 2D which are schematic isometric views and schematic front views of a segment of a dual-ridged waveguide that may be included in a waveguide junction, according to embodiments of the present invention.

As shown in FIGS. 2A and 2B, and as known in the art, a dual-ridged waveguide 10B may be implemented as a pipe having a polygonal (e.g., rectangular) cross section, where at least one dimension (e.g., a width of the pipe, marked as W2) may be set according to the working RF wavelength. A first ridge or inset 110 (e.g., 110A) may be placed along—e.g. extending along the length of—a first side 11 (e.g., 11A) of waveguide 10B, and a second ridge or inset 110 (e.g., 110B) may be placed along a second side 11 (e.g., 11B) of waveguide 10B thus forming a dual-ridged waveguide 10B.

Alternately, as shown in FIGS. 2C and 2D, and as known in the art, a dual-ridged waveguide 10B may be implemented as a pipe having a round or circular cross section, where at least one dimension (e.g., a width of the pipe, marked as W2′) may be set according to the working RF wavelength. A first ridge 110 (e.g., 110A) may be placed along a first side or arc 11 (e.g., 11A′) of waveguide 10B, and a second ridge 110 (e.g., 110B) may be placed along a second side or arc 11 (e.g., 11B′) of waveguide 10B thus forming a dual-ridged waveguide 10B.

Embodiments of the present invention may include a method for producing a waveguide junction, to transfer RF energy having a working frequency that may be equal to or higher than a predefined cutoff frequency between a dual ridge base waveguide and one or more (e.g., two) single ridged arm waveguides.

Embodiments of the invention may include: selecting a cutoff RF frequency; selecting a first single-ridged arm waveguide, a second single-ridged arm waveguide and a dual-ridged arm waveguide, each adapted to convey or carry RF energy at a frequency that is equal to or higher than the cutoff frequency, as known in the art; connecting the first single-ridged arm waveguide to the dual-ridged base waveguide in a first position; and connecting the second single-ridged arm waveguide to the dual-ridged base waveguide in a second position.

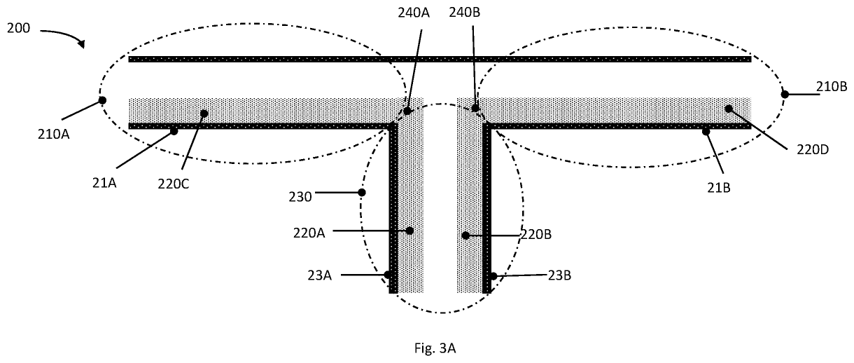

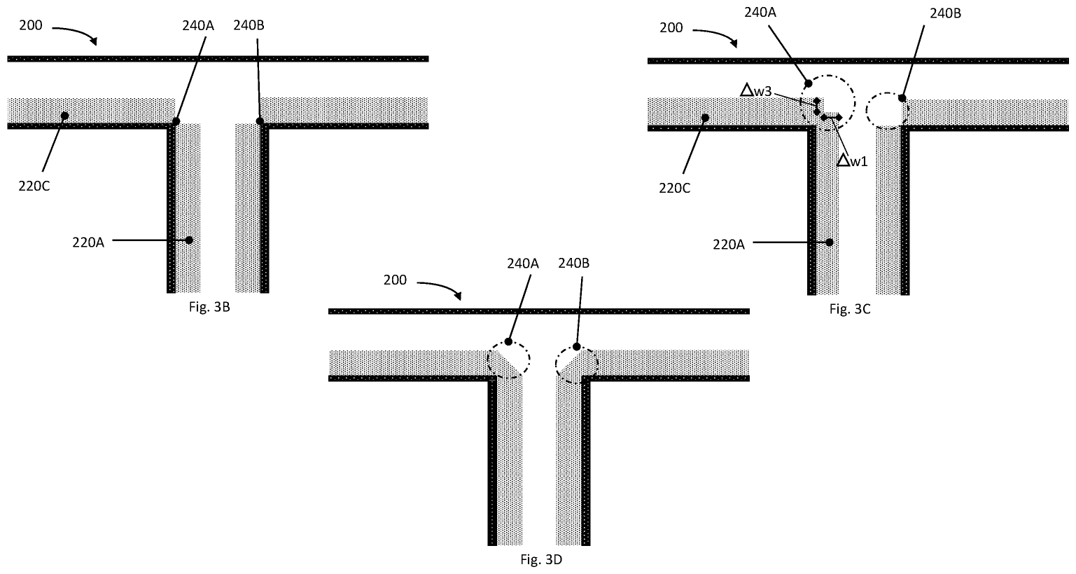

Reference is now made to FIG. 3A, 3B, 3C and 3D which are schematic cross-section views of a waveguide junction, according to different embodiments of the present invention.

As shown in FIGS. 3A, 3B, 3C and 3D, a waveguide junction 200 may include: a dual-ridged base waveguide 230; a single-ridged first arm waveguide 210A, connected to the base waveguide; and a single-ridged, second arm waveguide 210B, connected to base waveguide 230 and to first arm waveguide 210A.

According to some embodiments, dual-ridged base waveguide 230 may have or may be characterized by a polygonal (e.g., a rectangular) cross section (e.g., as depicted in FIGS. 2A and 2B).

Additionally, or alternately, at least one of first arm waveguide 210A and second arm waveguide 210B may have or may be characterized by a polygonal (e.g., a rectangular) cross section (e.g., as depicted in FIGS. 1A and 1B).

Additionally, or alternately, at least one of dual-ridged base waveguide 230, first arm waveguide 210A and second arm waveguide 210B may have or may be characterized by a circular or round cross section (e.g., as depicted in FIGS. 2C, 2D, 1C and 1D respectively).

According to some embodiments, dual-ridged base waveguide 230 may be connected perpendicularly to at least one of first arm waveguide 210A and second arm waveguide 210B.

Additionally, or alternately, first arm waveguide 210A may be colinear with second arm waveguide 210B. For example, base waveguide 230, first arm waveguide 210A and second arm waveguide 210B may be aligned in a perpendicular (e.g., in a right angle measuring 90 degrees) T-shaped junction, as shown in FIGS. 3A, 3B, 3C and 3D.

Additionally, or alternately, dual-ridged base waveguide 230 may be connected in a non-perpendicular angle to at least one of first arm waveguide 210A and second arm waveguide 210B. For example, base waveguide 230, first arm waveguide 210A and second arm waveguide 210B may be connected so as to form a Y-shaped junction. In other words base waveguide 230 may be connected to first arm waveguide 210A and second arm waveguide 210B in an obtuse angle (e.g., an angle measuring more than 90 degrees), to form a Y-shaped junction.

It would be appreciated that each waveguide of the first single-ridged arm waveguide, second single-ridged arm waveguide and dual-ridged arm waveguide may be connected to another waveguide of the first single-ridged arm waveguide, second single-ridged aim waveguide and dual-ridged arm waveguide in any method as known in the art. For example, a first waveguide (e.g., base waveguide 230) may be glued, welded, or held together by any mechanical means at a first end to a second waveguide (e.g., first arm waveguide 210A) at a second end to form a connection at a connection position (e.g., 240A). In another example, parts of waveguide junction 200 may be manufactured as a single, unified physical entity (e.g., by an etching or lathing machine). In such embodiments, the connection of a first waveguide (e.g., base waveguide 230) to a second waveguide (e.g., first arm waveguide 210A) may be inherently done as part of the manufacture process, as known in the art.

According to some embodiments, base waveguide 230 may include a first ridge 220A placed along a first side 23A of base waveguide 230 and a second ridge 220B placed along a second, opposite side 23B of base waveguide 230.

First arm waveguide 210A may include a third ridge 220C placed along a side 21A of first arm waveguide 210. Third ridge 20C may meet first ridge 220A in a first position 240A and third ridge 220C may be aligned with first ridge 220A in a common plane (e.g., the plane of the cross section depicted in FIGS. 3A, 3B, 3C and 3D).

As shown in FIGS. 3A, 3B, 3C and 3D, second arm waveguide 220B may include a fourth ridge 220D, placed along a side 21B of second arm waveguide 220B. Fourth ridge 220D may meet second ridge 220B in a second position 240B and may be is aligned with second ridge 220B in a common plane (e.g., the plane of the cross section depicted in FIGS. 3A, 3B, 3C and 3D), which may align with the plane of ridges 220A and 220C.

As shown in FIGS. 3A, 3B, 3C and 3D, first ridge 220A may meet or may be juxtaposed with third ridge 220C at first position 240A such that a cross-section of the waveguide junction 200 at first position 240A may include or have a first profile or shape, and second ridge 220B may meet or may be juxtaposed with fourth ridge 220D at second position 240B such that a cross-section of the waveguide junction 200 at second position 240B may include or have a second profile or shape that may or may not be similar or identical to the first profile.

The first profile or shape and second profile or shape may be or may include for example: a right-angled corner profile, a non-overlapping stair-shaped profile, a partially-overlapping stair-shaped profile, a trimmed right-angled corner profile and a rounded right-angled corner profile or any combination thereof, as elaborated herein.

It will be appreciated that other configurations of may be implemented to produce other types of profiles, as known in the art.

In some embodiments, as shown in FIG. 3A, first ridge or narrow inset 220A may be juxtaposed with third ridge or narrow inset 220C at first position 240A in a right-angled corner configuration, such that a width of first ridge 220A may fully overlap a width of third ridge 220C, to create a right-angled corner at position 240A. In other words, a cross-section of the waveguide junction at first position 240A may include a right-angled corner profile.

Additionally, or alternately, second ridge 220B may be juxtaposed with fourth ridge 220D at second position 240B such that a width of second ridge 220B may fully overlap a width of fourth ridge 220D, to create a right-angled corner at second position 240B. In other words, a cross-section of the waveguide junction at second position 240B may include a right-angled corner profile.

Additionally, or alternately, as shown in FIG. 3B, first ridge 220A may be juxtaposed with third ridge 220C at the first position 240A in a non-overlapping configuration, such that a cross-section of the waveguide junction at first position 240A may include a non-overlapping stair-shaped profile, where, for example, first ridge 220A may be manifested as a first stair and third ridge 220C may be manifested as a second stair.

Additionally, or alternately, second ridge 220B may be juxtaposed with fourth ridge 220D at second position 240B in a non-overlapping configuration, such that a cross-section of the waveguide junction at second position 240B may include a non-overlapping stair-shaped profile, where, for example, second ridge 220B may be manifested as a first stair and fourth ridge 220D may be manifested as a second stair.

Additionally, or alternately, as shown in FIG. 3C, first ridge 220A may be juxtaposed with third ridge 220C at first position 240A in a partially-overlapping configuration, such that a cross-section of the waveguide junction at first position 240A may include a partially-overlapping stair-shaped profile, where, for example at least a portion of a width of first ridge 220A (marked as Δω1) may be manifested by a first stair and at least a portion of a width of third ridge 220C (marked as Δω3) may be manifested by a second stair.

Additionally, or alternately, second ridge 220B may be juxtaposed with fourth ridge 220D at second position 240B in a partially-overlapping configuration, such that a cross-section of the waveguide junction at second position 240B may include a partially-overlapping stair-shaped profile, where, for example, at least a portion of a width of second ridge 220B may be manifested by a first stair and at least a portion of a width of fourth ridge 220D may be manifested by a second stair.

Additionally, or alternately, as shown in FIG. 3D, first ridge 220A may be juxtaposed with third ridge 220C at first position 240A in a trimmed right-angled corner configuration, to create a trimmed right-angled corner at position 240A. In other words, a cross-section of the waveguide junction at first position 240A may include a trimmed right-angled corner profile.

Additionally, or alternately, second ridge 220B may be juxtaposed with fourth ridge 220D at second position 240B, to create a trimmed right-angled corner at second position 240B. In other words, a cross-section of the waveguide junction at second position 240B may include a trimmed right-angled corner profile.

Additionally, or alternately, first ridge 220A may be juxtaposed with third ridge 220C at first position 240A in a rounded right-angled corner configuration, to create a rounded right-angled corner at position 240A. In other words, a cross-section of the waveguide junction at first position 240A may include a rounded right-angled corner profile.

Additionally, or alternately, second ridge 220B may be juxtaposed with fourth ridge 220D at second position 240B, to create a rounded right-angled corner at second position 240B. In other words, a cross-section of the waveguide junction at second position 240B may include a rounded right-angled corner profile.

It should be known that embodiments may further include any combination of the profiles as elaborated herein, including for example, a combination of a rounded right-angled corner profile and an overlapping stair-shaped profile and the like.

According to some embodiments, the profile at first position 240A may be similar or equivalent to the profile at second position 240B. For example, the profiles of first position 240A and second position 240B may both include a trimmed right-angled corner profile.

Alternately, the profile at first position 240A may be dissimilar from the profile at second position 240B, to produce a non-symmetrical junction, acting as an RF energy splitter and/or combiner with non-equal ratio.

For example, the profile of first position 240A may be a partially-overlapping stair-shaped profile, where (a) a first portion (e.g., 80%) of the width of first ridge 220A and third ridge 220C may be respectively manifested by the first and second stairs of the profile of first position 240A, and (b) a second portion (e.g., 20%) of the width of second ridge 220B and fourth ridge 220D may be respectively manifested by the first and second stairs of the profile of second position 240B.

The relative positioning of the ridges 220 (e.g., 220A in relation to 220C, 220B in relation to 220D) may be set so as to accommodate specifically required ratios of RF energy transfer through the junction. Pertaining to the same example, it has been shown experimentally, that in such configuration, where the profile of first position 240A resembles a right-angled corner profile and the profile of second position 240B resembles a non-overlapping stair-shaped profile, the ratio of transferred RF energy from base waveguide 230 to second waveguide 210B may be higher than the ratio of transferred RF energy from base waveguide 230 to first waveguide 210A.

According to some embodiments, a designer may define at least one of a first requirement for an RF transfer ratio (e.g., an RF transfer ratio above a first percentage) between base waveguide 230 and first arm waveguide 210A and a second requirement for an RF transfer ratio (e.g., an RF transfer ratio above a second percentage) between base waveguide 230 and second arm waveguide 210B. The designer may calculate the ratio of transferred RF energy by a commercially available tool for numerical simulation of RF energy propagation, as known in the art, to design and produce a junction that may accommodate the first and/or second requirements for RF transfer ratios.

The designer may set the position and/or shape of at least one ridge (e.g., the way ridges are met or juxtaposed as elaborated herein), so as to select at least one of the first profile and second profile at a respective at least one meeting point 240 (e.g., 240A, 240B), so as to transfer RF energy, at a working frequency of the waveguide junction, between base waveguide 230 and a respective arm waveguide 210 (e.g., 210A, 210B) at a required transfer ratio.

According to some embodiments, the first profile (e.g., at point 240A) may be dissimilar from the second profile (e.g., at point 240B), to produce a non-symmetrical junction. The non-symmetrical junction may be configured to operate for example, as an RF energy splitter having a non-equal splitting ratio or an RF energy combiner having a non-equal combining ratio.

According to some embodiments, the design process elaborated herein may include one or more iterations of design change (e.g., change in a location, position or size of one or more ridges) and RF propagation calculation (e.g., by a commercially available numeric simulation tool), until the at least one of first and second requirements for RF transfer ratios is met.

In other words, embodiments may include:

receiving a requirement for at least one RF transfer ratio (e.g., as part of a design of an RF system design); and

selecting at least one of the first profile and second profile according to the received requirement (e.g., of the at least one RF transfer ratio), wherein each one of the first profile and the second profile may be, for example: a right-angled corner profile, a non-overlapping stair-shaped profile, a partially-overlapping stair-shaped profile, a trimmed right-angled corner profile, a rounded right-angled corner profile and a combination thereof. The at least one of the first profile and second profile may be selected by the designer by the iterative designing process as elaborated herein, where properties of waveguide junction 200 such as RF transfer ratio are calculated numerically (e.g., by commercially available dedicated software), and the design of the junction (e.g., positioning of the ridges) is altered until the at least one received requirement is met.

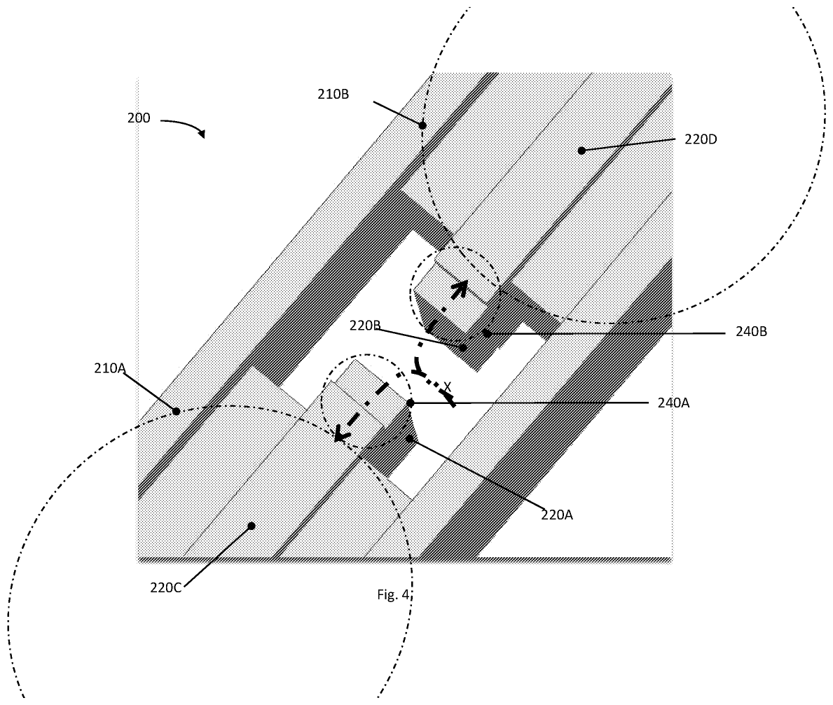

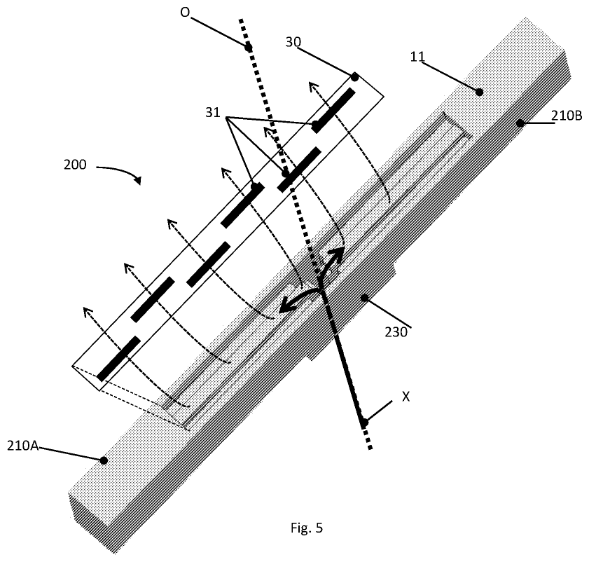

Reference is now made to FIG. 4 which is an isometric view of a waveguide junction, according to embodiments of the present invention. In FIG. 4, a portion of a side of first arm waveguide 210A and a portion of a side of second arm waveguide 210B opposite the base waveguide has been removed, to enable an isometric view of first positions 240A and 240B in a partially-overlapping configuration, as elaborated herein in relation to FIG. 3C. It may be appreciated by a person skilled in the art that RF energy that may be fed into base waveguide 230 (e.g., at a feed point marked ‘X’, between ridge 220A and ridge 220B), may propagate along base waveguide 230 at the direction of ridge 220A and ridge 220B, and may be split between first arm waveguide 210A (e.g., along ridge 220C) and second arm waveguide 210B (e.g., along ridge 220D), as shown by the dotted arrow lines of FIG. 4.

Reference is now made to FIG. 5 which is an isometric view of a waveguide junction 200, according to embodiments of the present invention. Waveguide junction 200 may include a gapped cover 30, positioned at a side 11 of first arm waveguide 210A and second arm waveguide 210B that is opposite base waveguide 230. Gapped cover 30 may include a plurality of gaps or apertures 31, configured to enable or allow emittance of RF energy therethrough.

RF energy may be fed into waveguide junction 200 at a feeding position (e.g., marked as ‘X’), and may propagate via base waveguide 230, and split evenly between arm waveguide 210A and arm waveguide 210B.

According to some embodiments, the length of arm waveguide 210A and arm waveguide 210B may be set so as to enable the propagated RF energy to resonate therein as a standing wave, as known in the art.

Arm waveguide 210A and arm waveguide 210B may be symmetric in relation to feeding point X, so as to allow symmetric resonance of RF energy between arm waveguide 210A and arm waveguide 210B.

According to some embodiments, Gapped cover 30 and the plurality of apertures 31 may also be symmetric in relation to feeding point X, so as to enable symmetric emittance of RF energy through apertures 31, in relation to a center-line (e.g., marked ‘0’) of base waveguide 230.

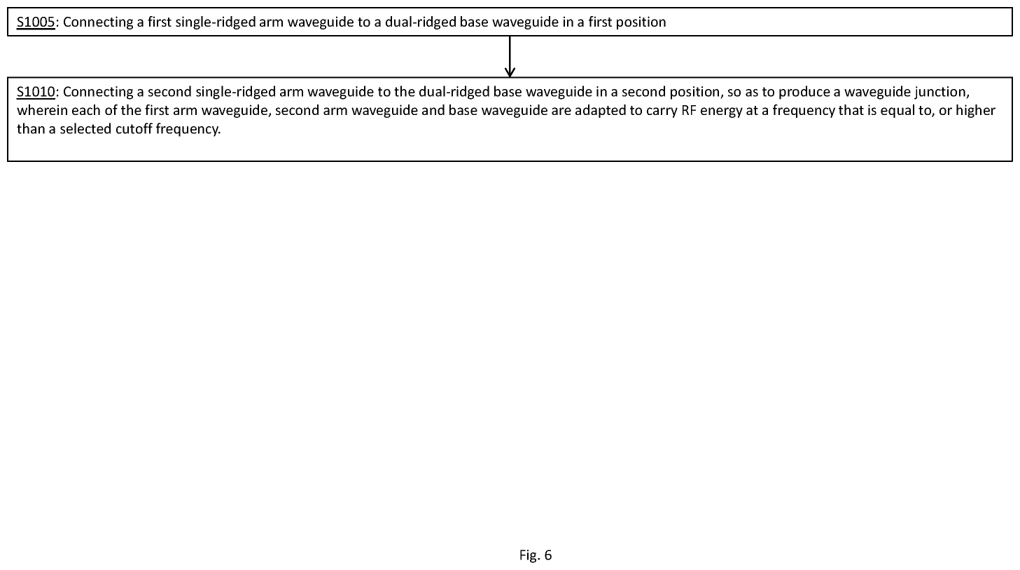

Reference is now made to FIG. 6 which is a flow diagram depicting a method of producing a waveguide junction, according to some embodiments of the invention.

As shown in step S1005, embodiments may include connecting a first single-ridged arm waveguide (e.g., such as depicted in FIG. 1A and/or FIG. 1C) to a dual-ridged base waveguide (e.g., such as depicted in FIG. 2A and/or FIG. 2C) in a first position.

As shown in step S1010, embodiments may include connecting a second single-ridged arm waveguide (e.g., such as depicted in FIG. 1A and/or FIG. 1C) to the dual-ridged base waveguide in a second position, so as to produce a waveguide junction (e.g., a T junction, such as depicted, for example, in FIG. 3A through FIG. 3D). Each of the first arm waveguide, second arm waveguide and base waveguide may be adapted to carry RF energy at a frequency that is equal or higher than a selected cutoff frequency.

Embodiments of the present invention may provide an improvement over currently available waveguide junctions, by combining the exploitation of the structural benefits of ridged waveguides (e.g., having a reduced dimensionality) with application of configurable characteristics of the conveyed RF energy.

For example, a designer may choose to split and/or combine, for example evenly, the propagation of conveyed RF energy between a central feeding point at the base waveguide and a pair of arm waveguides. This configuration may be advantageous for example, in embodiments where a gapped cover is applied as shown in FIG. 5. In such configurations, the central feeding of RF energy and the even split thereof to the two arm waveguides may produce an emitted signal through gapped cover 30 that may be characterized by superior integrity in relation to a commercially available configuration, in which a waveguide of an equivalent length (e.g., of the combined length of arms 210A and 210B) may be fed by an RF feeding point located at one extremity of the waveguide of the equivalent length.

Moreover, embodiments of the invention may enable a designer to define a first requirement for an RF transfer ratio (e.g., an RF transfer ratio above a first percentage) between base waveguide 230 and first arm waveguide 210A and a second requirement for an RF transfer ratio (e.g., an RF transfer ratio above a second percentage) between base waveguide 230 and second arm waveguide 210B, and design a waveguide junction that may accommodate at least one of the first requirement and second requirement, by an iterative numerical simulation process, as elaborated herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention. Further, features or elements of different embodiments may be used with or combined with other embodiments.

1. A waveguide junction comprising:
a base waveguide, comprising a first ridge and a second ridge;
a first arm waveguide, connected to the base waveguide, and comprising a third ridge; and
a, second arm waveguide, connected to the base waveguide and to the first arm waveguide and comprising a fourth ridge,
wherein the third ridge meets the first ridge in a first position, such that a cross-section of the wave. aide junction at the first position comprises a first stair-shaped profile.

2. The waveguide junction of claim 1, wherein the base waveguide, the first arm waveguide and the second arm waveguide are aligned in a perpendicular T-shaped junction.

3. The waveguide junction of claim 1, wherein the base waveguide is connected to at least one of the first arm waveguide and second arm waveguide so as to form a Y-shaped junction.

4. The waveguide junction according to claim 1, wherein at least one of the base waveguide, the first arm waveguide and the second arm waveguide are characterized by one of a rectangular cross section and a circular cross section.

5. (canceled)

6. The waveguide junction according to claim 1, wherein the fourth ridge meets the second ridge in a second position, such that a cross-section of the waveguide junction at the second position comprises a second profile, and wherein the second profile is selected from a list consisting of: a right-angled corner profile, a non-overlapping stair-shaped profile, a partially-overlapping stair-shaped profile, a trimmed right-angled corner profile, a rounded right-angled corner profile and a combination thereof.

7. The waveguide junction according to claim 1, wherein the fourth ridge meets the second ridge in a second position, such that a cross-section of the waveguide junction at the second position comprises a second profile, and wherein at least one of the first profile and the second profile is selected so as to transfer RF energy, at a working frequency of the waveguide junction, between the base waveguide and a respective arm waveguide at a required transfer ratio.

8. The waveguide junction according to claim 1, wherein the fourth ridge meets the second ridge in a second position, such that a cross-section of the waveguide junction at the second position comprises a second profile, and wherein the first profile is dissimilar from the second profile, to produce a non-symmetrical junction, configured to operate as at least one of an RF energy splitter having a non-equal splitting ratio and an RF energy combiner having a non-equal combining ratio.

9. A waveguide junction comprising:
a base waveguide,
a first arm waveguide, connected to the base waveguide; and
a second arm waveguide connected to the base waveguide,
wherein the base waveguide comprises a first ridge placed along a first side of the base waveguide and a second ridge placed along a second side of the base waveguide, wherein the first arm waveguide comprises a third ridge placed along a side of the first arm waveguide and wherein the second arm waveguide comprises a fourth ridge placed along a side of the second arm waveguide,
and wherein the third ridge meets the first ridge in a first position. such that a cross-section of the waveguide junction at the first position comprises a first stair-shaped profile.

10. The waveguide junction of claim 9, and wherein the first arm waveguide is perpendicular to the base waveguide and colinear with the second arm waveguide so as to form a perpendicular T-shaped junction.

11. The waveguide junction of claim 9, wherein the base waveguide is connected to at least one of the first arm waveguide and second arm waveguide so as to form a Y-shaped junction.

12. The waveguide junction of claim 9, wherein one or more of the base waveguide, the first arm waveguide and the second arm waveguide have a rectangular cross section.

13. (canceled)

14. (canceled)

15. The waveguide junction of claim 9, wherein the fourth ridge meets the second ridge in a second position, and wherein the second ridge is juxtaposed with the fourth ridge at the second position such that a cross-section of the waveguide junction at the second position comprises a second profile and wherein the second profile is selected from a list consisting of: a right-angled corner profile, a non-overlapping stair-shaped profile, a partially-overlapping stair-shaped profile, a trimmed right-angled corner profile, a rounded right-angled corner profile and a combination thereof.

16. The waveguide junction of claim 15, wherein the first profile is dissimilar from the second profile, to produce a non-symmetrical junction, configured to operate as at least one of an RF energy splitter, with non-equal splitting ratio and an RF energy combiner, with non-equal combining ratio.

17. The waveguide junction of claim 16, wherein the first ridge is juxtaposed with the third ridge at the first position such that at least a portion of a width of the first ridge is manifested by a first stair in the first profile and at least a portion of a width of the third ridge is manifested by a second stair in the first profile.

18. The waveguide junction of claim 9, wherein the second ridge is juxtaposed with the fourth ridge at the second position such that at least a portion of a width of the second ridge is manifested by a first stair in the second profile and at least a portion of a width of the fourth ridge is manifested by a second stair in the second profile.

19. The waveguide junction of claim 9, further comprising a cover, positioned at a side of the first arm waveguide and second arm waveguide that is opposite to the base waveguide, wherein the cover comprises one or more apertures, so as to allow emittance of RF energy through the apertures, and wherein the emittance of RF energy through the apertures is symmetric in relation to a center-line of the base waveguide.

20. A method of producing a waveguide junction, the method comprising:
connecting a first single-ridged arm waveguide to a dual-ridged base waveguide in a first position, wherein a ridge of the first single-ridged arm waveguide meets a first ridge of the dual-ridged base waveguide in a first position, such that a cross-section of the waveguide junction at the first position comprises a first stair-shaped profile; and
connecting a second single-ridged arm waveguide to the dual-ridged base waveguide in a second position,
wherein each of the first arm waveguide, second arm waveguide and base waveguide are adapted to carry RF energy at a frequency that is equal or higher than a selected cutoff frequency.

21. The method of claim 20 wherein connecting the second arm waveguide to the base waveguide comprises juxtaposing a ridge of the second arm waveguide with a second ridge of the base waveguide in the second position, such that a cross-section of the waveguide junction at the second position comprises a second profile.

22. The method of claim 21, further comprising: selecting the second profile according to a received required RF transfer ratio, wherein the second profile is selected from a list consisting of: a right-angled corner profile, a non-overlapping stair-shaped profile, a partially-overlapping stair-shaped profile, a trimmed right-angled corner profile, a rounded right-angled corner profile and a combination thereof.

23. The waveguide junction of claim 1, wherein a portion of a width of the first ridge is manifested by a first stair and at least a portion of a width of the third ridge is manifested by a second stair.
